(19) United States
(12) Patent Application Publication
(10) Pub. No.: US 2024/0002144 A1
(43) Pub. Date: Jan. 4, 2024

(54) Wet Sand Loading System

(71) Applicants: Adam Wennerberg, Bloomer, WI (US); Josh Clements, Dover, OK (US); Brandon Peterson, Bloomer, WI (US); Greg Clements, Bloomer, WI (US)

(72) Inventors: Adam Wennerberg, Bloomer, WI (US); Josh Clements, Dover, OK (US); Brandon Peterson, Bloomer, WI (US); Greg Clements, Bloomer, WI (US)

(21) Appl. No.: 17/853,370

(22) Filed: Jun. 29, 2022

(51) Int. Cl. B65D 88/28; B65G 11/02; B65G 47/44; B65G 65/32

(52) U.S. Cl. CPC B65D 88/28; B65G 11/026; B65G 47/44; B65G 65/32; B65G 2201/045

(57) ABSTRACT

A wet sand loading system includes a material conveyor configured for carrying wet sand from a hopper to an elevated position over a loading platform. A funnel assembly is coupled to the material conveyor. The funnel assembly has a lower end movable relative to the material conveyor to direct wet sand into the hopper in a selectable direction.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to sand loading systems and more particularly pertains to a new sand loading system for evenly dispensing wet sand in a safe and evenly distributed manner.

### (2) DESCRIPTION OF RELATED ART INCLUDING INFORMATION DISCLOSED UNDER 37 CFR 1.97 AND 1.98

The prior art relates to sand loading systems which have difficulty in consistent loading of wet sand. They are subject to uneven weight distribution, inconsistent volume within containers, and other issues leading to shipping of sand dry instead of wet. For applications calling for wet sand this results in time and expense to wet the dry sand prior to use.

### BRIEF SUMMARY OF THE INVENTION

An embodiment of the disclosure meets the needs presented above by generally comprising a material conveyor configured for carrying wet sand from a hopper to an elevated position over a loading platform. A funnel assembly is coupled to the material conveyor. The funnel assembly has a lower end movable relative to the material conveyor to direct wet sand into the hopper in a selectable direction.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a wet sand loading system according to an embodiment of the disclosure.

FIG. 2 is a front side perspective view of a funnel assembly of an embodiment of the disclosure.

FIG. 3 is a rear view of an embodiment of the disclosure.

FIG. 4 is a perspective view of an embodiment of the disclosure.

FIG. 5 is a front side perspective view of a first funnel assembly of an embodiment of the disclosure.

FIG. 6 is a front side perspective view of a second funnel assembly of an embodiment of the disclosure.

### DETAILED DESCRIPTION OF THE INVENTION

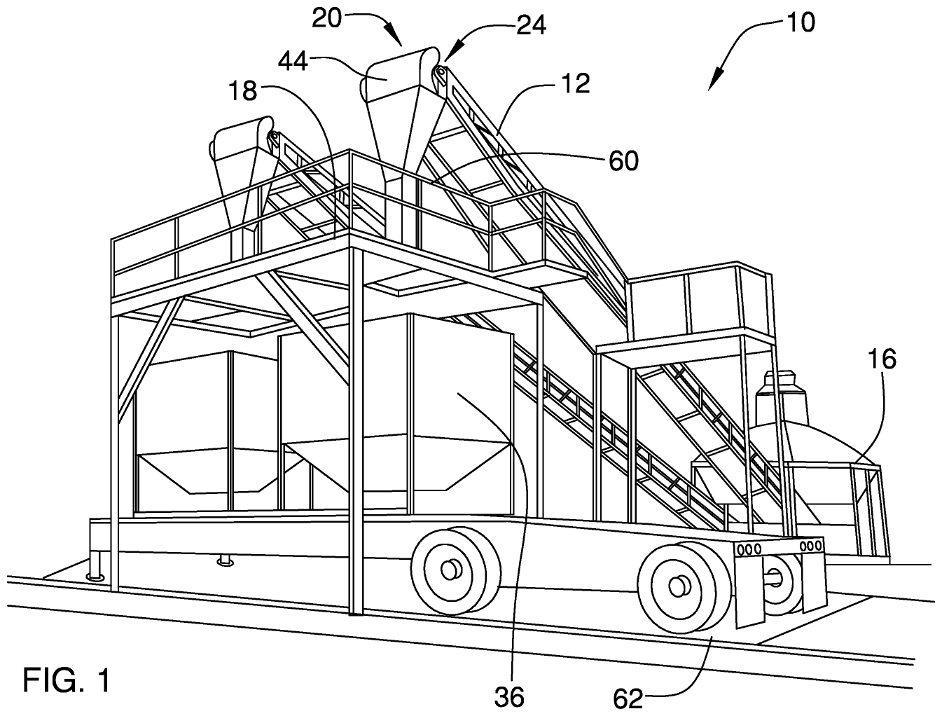

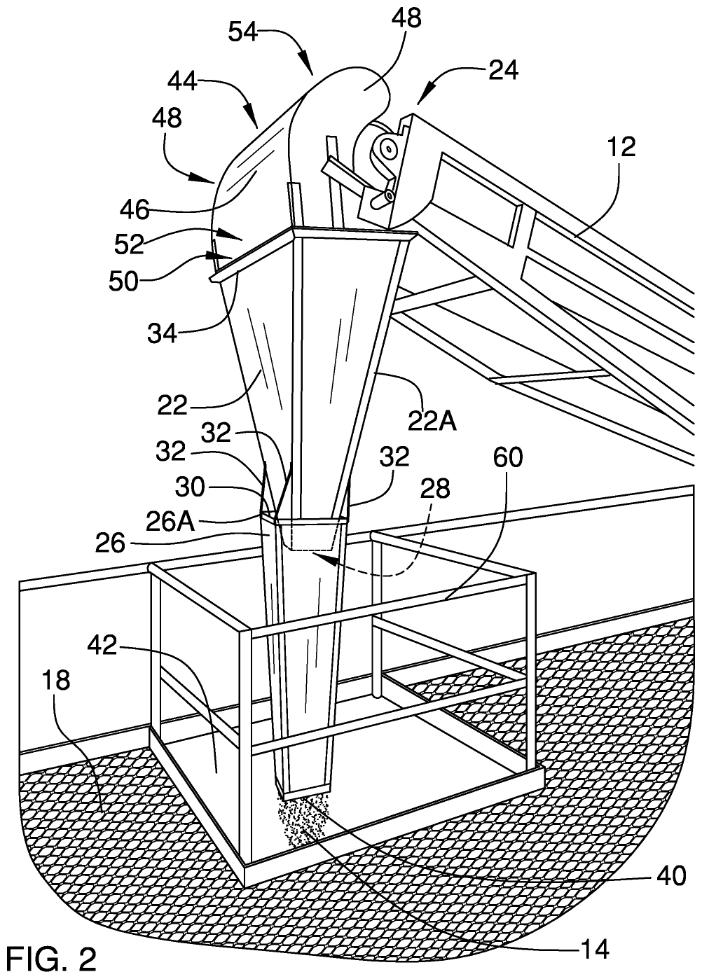

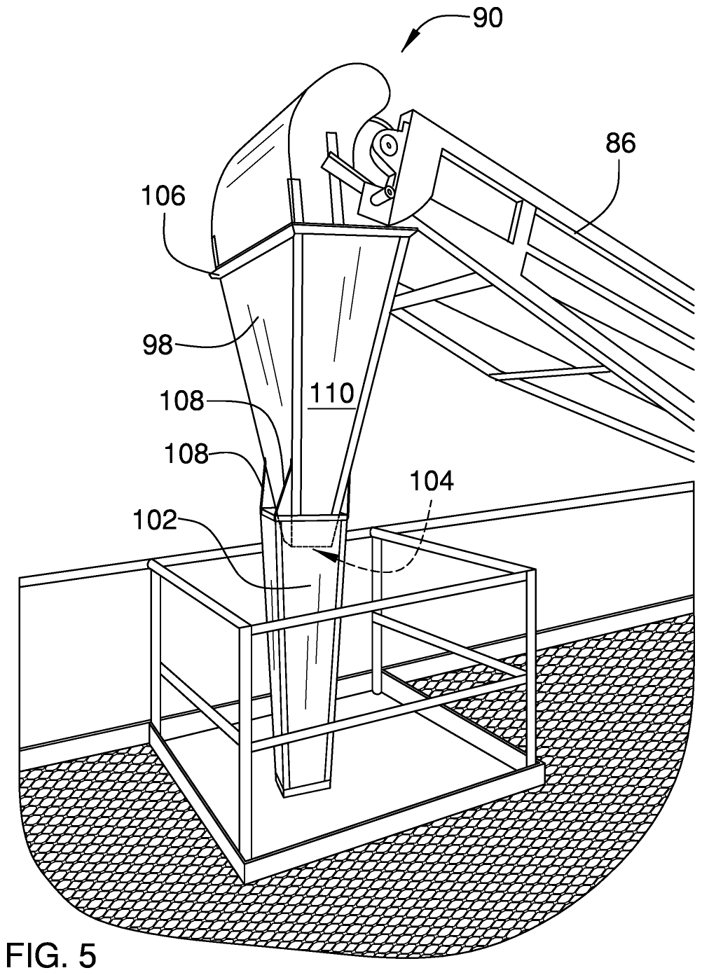

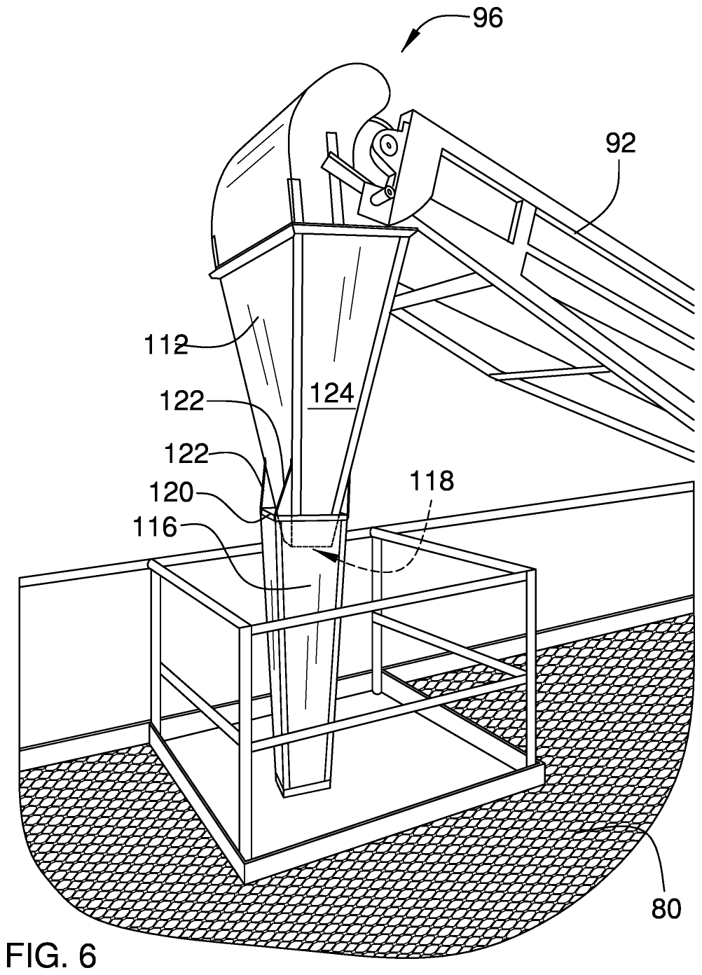

With reference now to the drawings, and in particular to FIGS. 1 through 6 thereof, a new sand loading system embodying the principles and concepts of an embodiment of the disclosure and generally designated by the reference numeral 10 will be described.

As best illustrated in FIGS. 1 through 6, the wet sand loading system 10 generally comprises a material conveyor 12 configured for carrying wet sand 14, or similar material, from a hopper 16 to an elevated position over a loading platform 18. A funnel assembly 20 is coupled to the material conveyor 12. The material conveyor 12 may be a conveyor belt, auger, or other conventional conveyance of the type known for moving material such as sand, rocks, grains, and other materials. The funnel assembly 20 includes an upper funnel portion 22 adjacent to a dispensing end 24 of the material conveyor 12. The upper funnel portion 22 is configured to receive the wet sand 14 from the material conveyor 12. The upper funnel portion 22 is in a fixed position relative to the material conveyor 12 or to the loading platform 18. The upper funnel portion 22 is positioned such that a central longitudinal axis of the upper funnel portion 22 is vertical. A lower funnel portion 26 is movably coupled to the upper funnel portion 22. A bottom 28 of the upper funnel portion 22 extends into a top end 30 of the lower funnel portion 26. This overlap prevents the wet sand 14 spilling through a gap between the upper funnel portion 22 and the lower funnel portion 26. Each of a plurality of lines 32 extends between the upper funnel portion 22 and the lower funnel portion 26. The top end 30 of the lower funnel portion 26 is spaced from an outer surface 34 of the upper funnel portion 22 wherein the lower funnel portion 26 is hung from the upper funnel portion 22 and is movable relative to the upper funnel portion 22. The lower funnel portion 26 has a bottom end 40 spaced from the top end 30 of the lower funnel portion 26 such that the lower funnel portion 26 is configured to extend through an opening 42 in the loading platform 18. The lower funnel portion 26 can be moved to direct the wet sand 14 into a vessel 36 under the opening 42 of the loading platform 18 in a manner preventing the wet sand 14 from building up in one place within the vessel 36. The wet sand 14 can be distributed more evenly throughout an interior of the vessel 36. The lower funnel portion 26 is also elongated allowing for directing of the wet sand 14 at relatively slight angle from vertical such that gravitational force on the wet sand 14 is sufficient to deliver the wet sand 14 to the vessel 36 with sufficient surge to inhibit air pockets within the vessel 36. The lower funnel portion 26 is movable relative to the upper funnel portion 22 such that the lower funnel portion 26 is configured for being moved to dispense the wet sand 14 into a desired position within the vessel 36.

A shroud 44 may be coupled to the upper funnel portion 22. The shroud 44 extends from a top 34 of the upper funnel portion 22 and around the dispensing end 24 of the material conveyor 12. The shroud 44 is configured to direct the wet sand 14 vertically downward from the material conveyor 12 into the upper funnel portion 22. The shroud 44 has a middle panel 46 extending between a pair of outer panels 48. The middle panel 46 is coextensive with and coupled to a top edge 50 of the upper funnel portion 22. Each of the outer panels 48 is coupled to and extends from opposite ends of the middle panel 46. The middle panel 46 has a planar lower portion 52 and a curved upper portion 54 extending up and around the dispensing end 24 of the material conveyor 12.

The upper funnel portion 22 has a rectangular shape perpendicular to a central longitudinal axis of the upper funnel portion 22. The lower funnel portion 26 is rectangular shaped perpendicular to a longitudinal axis of the lower funnel portion 26. Each of the lines 32 extends between a respective corner edge 22A of the upper funnel portion 22 and an adjacent corner 26A of the top end 30 of the lower funnel portion 26.

A rail 60 may be coupled to the loading platform 18. The rail 60 extends around the opening 42 for safety so a person is inhibited from falling into the opening 42. The lower funnel portion 26 is positioned adjacent to the rail 60 wherein the lower funnel portion 26 is configured for being manipulated by a person standing on the loading platform 18 adjacent to the rail 60. At a position along the rail 60, the person can look down into the vessel 36 and manipulate the lower funnel portion 26 to direct wet sand 14 into the vessel 36. The loading platform 18 may also be positioned over a scale 62. The scale 62 can be zeroed or a pre-fill weight can be determined so that the scale 62 can be used to accurately determine how much wet sand 14 is deposited into the vessel 36.

The above describes a single delivery mechanism from the first hopper 16 to the vessel 36. However, the wet sand loading system 10 may provide for dual mechanisms as described below. Generally, except where noted, the structures below are similar or identical to the structures described above and variations in the structures above may be equally incorporated into the structures described below.

A loading platform 80 has a first opening 82 and a second opening 84. A first material conveyor 86 is configured for carrying wet sand 14 from a first hopper 88 to an elevated position over the first opening 82 in the loading platform 80. A first funnel assembly 90 is coupled to the first material conveyor 86. A second material conveyor 92 is configured for carrying wet sand 14 from a second hopper 94 adjacent to the first hopper 88 to the elevated position over the second opening 84 in the loading platform 80. A second funnel assembly 96 is coupled to the second material conveyor 92.

Similar to the above, the first funnel assembly 90 includes a first funnel assembly upper funnel portion 98 adjacent to a dispensing end 100 of the first material conveyor 86 wherein the first funnel assembly upper funnel portion 98 is configured to receive the wet sand 14 from the first material conveyor 86. The first funnel assembly upper funnel portion 98 is in a fixed position relative to the first material conveyor 86 or the loading platform 80. A first funnel assembly lower funnel portion 102 is movably coupled to the first funnel assembly upper funnel portion 98. A bottom 104 of the first funnel assembly upper funnel portion 98 extends into a top 106 of the first funnel assembly lower funnel portion 98. Each of a plurality of first funnel assembly lines 108 extends between the first funnel assembly upper funnel portion 98 and the first funnel assembly lower funnel portion 102. The top 106 of the first funnel assembly lower funnel portion 102 is spaced from an outer surface 110 of the first funnel assembly upper funnel portion 98 wherein the first funnel assembly lower funnel portion 102 is hung from the first funnel assembly upper funnel portion 98 and movable relative to the first funnel assembly upper funnel portion 98.

The second funnel assembly 96 includes a second funnel assembly upper funnel portion 112 adjacent to a dispensing end 114 of the second material conveyor 92 wherein the second funnel assembly upper funnel portion 112 is configured to receive the wet sand 14 from the second material conveyor 92. The second funnel assembly upper funnel portion 112 is in a fixed position relative to the second material conveyor 92 of the loading platform 80. A second funnel assembly lower funnel portion 116 is movably coupled to the second funnel assembly upper funnel portion 112. A bottom 118 of the second funnel assembly upper funnel portion 112 extends into a top 120 of the second funnel assembly lower funnel portion 116. Each of a plurality of second funnel assembly lines 122 extends between the second funnel assembly upper funnel portion 112 and the second funnel assembly lower funnel portion 116. The top 120 of the second funnel assembly lower funnel portion 116 is spaced from an outer surface 124 of the second funnel assembly upper funnel portion 112 wherein the second funnel assembly lower funnel portion 116 is hung from the second funnel assembly upper funnel portion 112 and is movable relative to the second funnel assembly upper funnel portion 112.

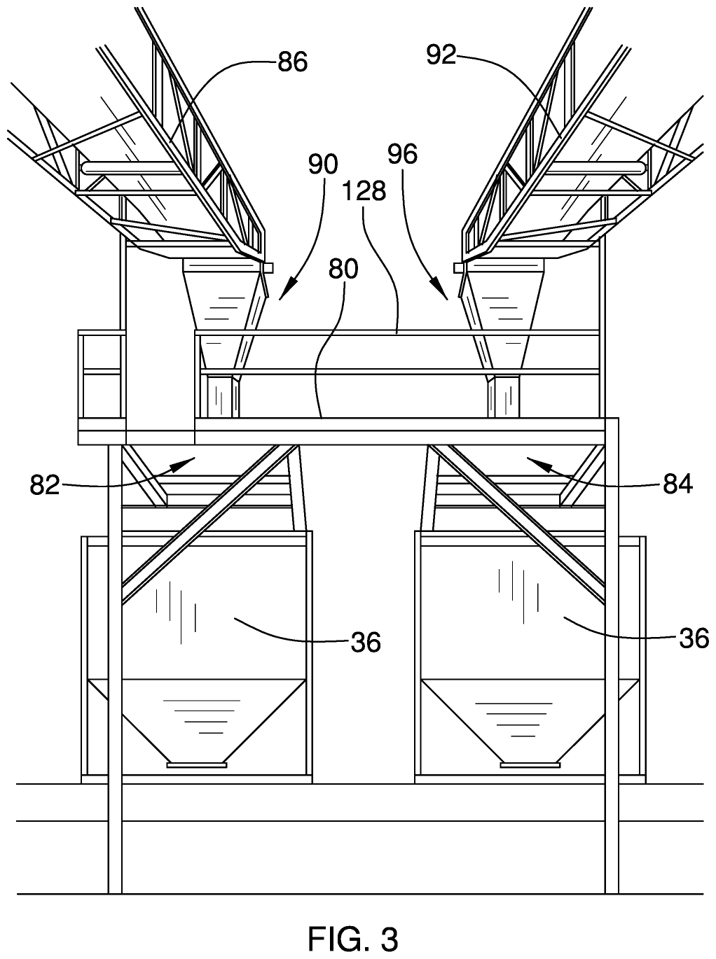

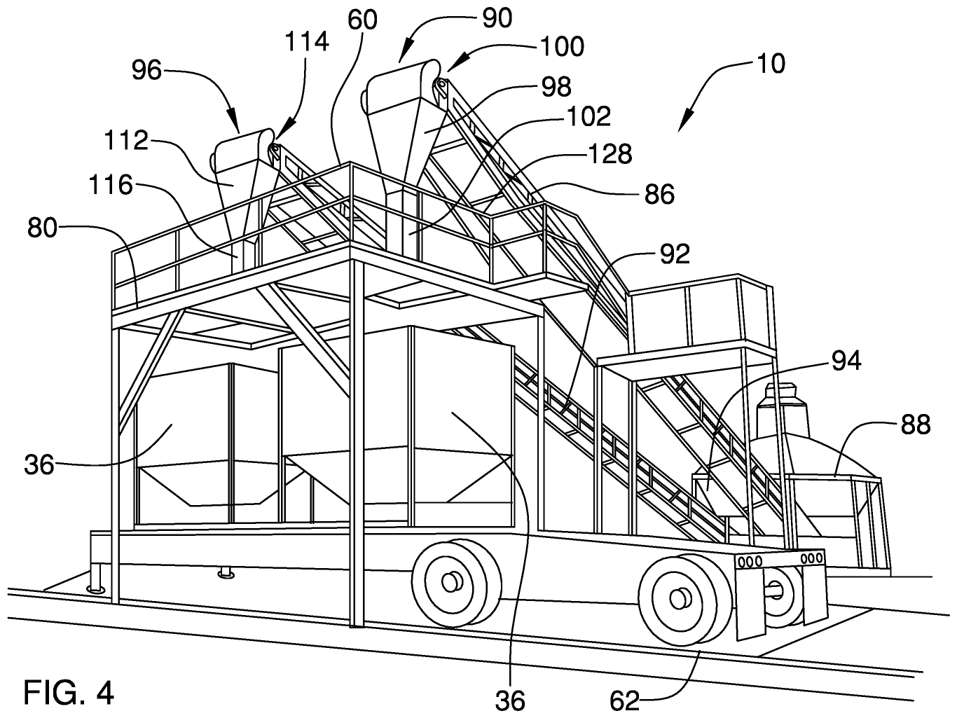

The dual mechanism for wet sand delivery as shown in FIGS. 3 and 4 may also employ a rail 128 similar to rail 60 as described above and each of the first and second funnel assemblies can be manipulated as described above. Further, any of the above described lower funnel portions can be moved using mechanical structures such as rams, pistons, or similar devices. Monitoring of the filing of the vessels 36 can be done through visual inspection by a person on the loading platform 18 or 80. Alternatively, cameras or other monitors of conventional design may be employed allowing for remote control of any mechanism for moving the respective lower funnels portions for filling the vessels.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A wet sand loading device comprising:
a material conveyor, said material conveyor being configured for carrying wet sand from a hopper to an elevated position over a loading platform;
a funnel assembly coupled to said material conveyor, a lower end of said funnel assembly being movable relative to said material conveyor wherein said funnel assembly is configured to direct the wet sand into the hopper in a selectable direction.

2. The wet sand loading device wherein said funnel assembly comprises:
an upper funnel portion adjacent to a dispensing end of said material conveyor wherein said upper funnel portion is configured to receive the wet sand from the material conveyor, said upper funnel portion being in a fixed position relative to said material conveyor,
a lower funnel portion being movably coupled to said upper funnel portion, a bottom of said upper funnel portion extending into a top of said lower funnel portion, and
a plurality of lines extending between said upper funnel portion and said lower funnel portion, said top of said lower funnel portion being spaced from an outer surface of said upper funnel portion wherein said lower funnel portion is hung from said upper funnel portion and movable relative to said upper funnel portion.

3. The wet sand loading device of claim 2, further comprising a central longitudinal axis of said upper funnel portion being vertical.

4. The wet sand loading device of claim 2, further comprising said lower funnel portion having a bottom end spaced from said top end of said lower funnel portion such that said lower funnel portion is configured to extend through an opening in the loading platform.

5. The wet sand loading device of claim 4, further comprising said lower funnel portion being movable relative to said upper funnel portion such that said lower funnel portion is configured for being moved to dispense the wet sand deposited into said upper funnel portion into a desired position within a receiving vessel positioned under the opening in the loading platform.

6. The wet sand loading device of claim 2, further comprising a shroud coupled to said upper funnel portion, said shroud extending from a top of said upper funnel portion and around said dispensing end of said material conveyor wherein said shroud is configured to direct the wet sand vertically downward from the material conveyor into the upper funnel portion.

7. The wet sand loading device of claim 6, further comprising said shroud having a middle panel extending between a pair of outer panels, said middle panel being coextensive with and coupled to a top edge of said upper funnel portion, each of said outer panels being coupled to and extending from opposite ends of said middle panel.

8. The wet sand loading device of claim 7, further comprising said middle panel having a planar lower portion and a curved upper portion extending up and around said dispensing end of said material conveyor.

9. The wet sand loading device of claim 2, further comprising said upper funnel portion having a rectangular shape perpendicular to a central longitudinal axis of said upper funnel portion.

10. The wet sand loading device of claim 9, further comprising said lower funnel portion being rectangular shaped perpendicular to a longitudinal axis of said lower funnel portion.

11. The wet sand loading device of claim 10, further comprising each of said lines extending between a respective corner edge of said upper funnel portion and an adjacent corner of said top end of said lower funnel portion.

12. A wet sand loading system comprising:
a loading platform having an opening;
a material conveyor, said material conveyor being configured for carrying wet sand from a hopper to an elevated position over said opening in said loading platform;
a funnel assembly coupled to said material conveyor, said funnel assembly comprising
an upper funnel portion adjacent to a dispensing end of said material conveyor wherein said upper funnel portion is configured to receive the wet sand from the material conveyor, said upper funnel portion being in a fixed position relative to said material conveyor,
a lower funnel portion being movably coupled to said upper funnel portion, a bottom of said upper funnel portion extending into a top of said lower funnel portion, and
a plurality of lines extending between said upper funnel portion and said lower funnel portion, said top of said lower funnel portion being spaced from an outer surface of said upper funnel portion wherein said lower funnel portion is hung from said upper funnel portion and movable relative to said upper funnel portion.

13. The wet sand loading system of claim 12, further comprising a rail coupled to said loading platform, said rail extending around the opening, the lower funnel portion being positioned adjacent to said rail wherein said lower funnel portion is configured for being manipulated by a person standing on said loading platform adjacent to said rail.

14. The wet sand loading system of claim 12, further comprising said loading platform being positioned over a scale.

15. A wet sand loading system comprising:
a loading platform having a first opening and a second opening;
a first material conveyor, said first material conveyor being configured for carrying wet sand from a first hopper to an elevated position over said first opening in said loading platform;
a first funnel assembly coupled to said first material conveyor;
a second material conveyor, said second material conveyor being configured for carrying wet sand from a second hopper adjacent to said first hopper to the elevated position over said second opening in said loading platform;
a second funnel assembly coupled to said second material conveyor.

16. The wet sand loading system of claim 14, wherein said first funnel assembly comprises:
a first funnel assembly upper funnel portion adjacent to a dispensing end of said first material conveyor wherein said first funnel assembly upper funnel portion is configured to receive the wet sand from the first material conveyor, said first funnel assembly upper funnel portion being in a fixed position relative to said first material conveyor,
a first funnel assembly lower funnel portion being movably coupled to said first funnel assembly upper funnel portion, a bottom of said first funnel assembly upper funnel portion extending into a top of said first funnel assembly lower funnel portion, and
a plurality of first funnel assembly lines extending between said first funnel assembly upper funnel portion and said first funnel assembly lower funnel portion, said top of said first funnel assembly lower funnel portion being spaced from an outer surface of said first funnel assembly upper funnel portion wherein said first funnel assembly lower funnel portion is hung from said first funnel assembly upper funnel portion and movable relative to said first funnel assembly upper funnel portion;

17. The wet sand loading system of claim 16, wherein said second funnel assembly comprises:
a second funnel assembly upper funnel portion adjacent to a dispensing end of said second material conveyor wherein said second funnel assembly upper funnel portion is configured to receive the wet sand from the second material conveyor, said second funnel assembly upper funnel portion being in a fixed position relative to said second material conveyor,
a second funnel assembly lower funnel portion being movably coupled to said second funnel assembly upper funnel portion, a bottom of said second funnel assembly upper funnel portion extending into a top of said second funnel assembly lower funnel portion, and
a plurality of second funnel assembly lines extending between said second funnel assembly upper funnel portion and said second funnel assembly lower funnel portion, said top of said second funnel assembly lower funnel portion being spaced from an outer surface of said second funnel assembly upper funnel portion wherein said second funnel assembly lower funnel portion is hung from said second funnel assembly upper funnel portion and movable relative to said second funnel assembly upper funnel portion.
